(19) United States
(12) Patent Application Publication
(10) Pub. No.: US 2013/0273206 A1
(43) Pub. Date: Oct. 17, 2013

(54) ALL-NATURAL PROTEIN-BASED BOTH SOFT AND HARD FOOD IN ONE FOR PETS

(71) Applicant: Reynolds Ellsworth Moulton, Brooklyn, NY (US)

(72) Inventor: Reynolds Ellsworth Moulton, Brooklyn, NY (US)

(21) Appl. No.: 13/445,890

(22) Filed: Apr. 12, 2012

(51) Int. Cl. A23K 1/18; A23K 1/175; A23L 1/302; A23B 4/03; A23P 1/08; A23K 1/10; A23K 1/16; A23P 1/12

(52) U.S. Cl. 426/62; 426/92; 426/74; 426/383

(57) ABSTRACT

The embodiments herein provide an all-natural soft and dry food in one products for pets, and a method of manufacturing the same. According to an embodiment herein, the food product comprises a hard outer shell made up of animal-based protein with a moisture content of 10-15% and a soft and highly moist inner core. The soft and dry food meets the health requirement of pets as they have naturally evolved to ingest and digest foods by providing teeth cleaning attributes, maintaining proper sugar, glycemic levels etc. The soft and dry food eliminates the need for adding wet canned food to make the pet to consume the food. The soft and dry food provides inherent palatability and moisture content. The manufacturing process comprises pre-processing, conditioning and extrusion, drying, cooling, enrobing and finally packaging finished product. In the drying step, the extruded food sample is subjected to three-step heating cycle.

### BACKGROUND

1. Technical Field

The embodiments herein generally relate to food products for animals and particularly relates to a food product with soft and hard characteristics for pets. The embodiments herein more particularly relate to dual-textured, and high-moisture product with enhanced palatability and superior mouth-feel characteristics for pet food product and a process of manufacturing the same.

2. Description of the Related Art

Pets such as dogs and cats differ slightly in how they prioritize taste preferences in food versus humans. The attractability level of food for dogs and cats is most often described as their “palatability”. While humans prioritize the preference criteria for food as taste, scent, texture, mouth-feel, etc., the dogs and cats have a higher predilection for mouth feel (“unami”) in their preference hierarchy, as their palettes have not significantly changed as much as humans. The pet's instinctual preferences are for foods that are similar to food from how it would be found in the wild (preferences that have not evolved from the over 10,000 years they have cohabitated with humans), where texture is a key indicator of food safety. The pets generally are attracted towards texture, taste and aroma of the food. In nature, most core foods especially for pets are naturally both hard and wet with higher moisture content.

Also, while “kibble” or dry food, by far, is the type of pet food sold in the world at the highest percentages, the millions of pet owners find that they have to add either wet food, or moist food to kibble in order to have their dogs or cats to actually consume this type or form of food. There are different types of pet food products with different properties based on the age and breeds of pets thereby leading to a confusion for the pet owner in selecting a required pet food.

One of the prior arts provides a pet food product comprising a shell component that completely surrounds an inner component to form one dual textured pet food product. The food product also increases the palatability. The pet food of the prior arts explains exclusively about a hairball treatment in pets and does not address other health issues such as a dental health (teeth cleansing attributes), control obesity in pet by maintaining sugar, glycemic carbohydrate level etc. Thus, the pets need to be given a food product corresponding to the particular issues for improving the health, in case of health issues other than a hairball formation. There is a no single food product which provides a palatable food with many health improving properties for the pets based on their evolutionary health needs.

Another prior art method provides a process of making a dry pet food having hard and soft component. The food product is crunchy but the soft component has limited moisture. Thus a pet does not eat the food completely due to less palatability. Sometimes the canned food is added to the dry food for changing the texture and increasing the palatability. The process of adding canned (wet) food increases time and cost for the pet owners.

Hence, there is need for a wet and dry food in one product with high moisture content for pets for increasing the palatability. Further there is need for a single wet and dry food in one product which fulfills all the health needs of the pets. Still further, there is a need for a wet and dry food in one product which is economical and does not require a mixing of wet (canned) food with a hard food.

The abovementioned shortcomings, disadvantages and problems are addressed herein and which will be understood by reading and studying the following specification.

### OBJECTS OF THE EMBODIMENTS

The primary object of the embodiments herein is to provide an all natural protein based wet and dry food in one product which is hard from outside and wet from inside/middle for the pets.

Another object of the embodiments herein is to provide a simple, full-spectrum natural food product with meat based protein for the pets of all ages and breeds.

Yet another object of the embodiments herein is to provide an all natural protein based wet and dry in one food product with animal based protein for the pets to cover most of the health requirements of the pets.

Yet another object of the embodiments herein is to provide an all natural protein based wet and dry in one food product for the pets to provide a food product with a natural texture, enhanced palatability and mouth feel characteristics.

Yet another object of the embodiments herein is to provide an all natural protein based wet and dry in one food product for the pets to eliminate a need for mixing a wet (canned) food with a hard dry food.

Yet another object of the embodiments herein is to provide a method of manufacturing an all natural protein based wet and dry in one food product comprising an animal based protein for the pets.

Yet another object of the embodiments herein is to provide a manufacturing process of an all natural protein based wet and dry in one food product for the pets by employing a drying and heating process instead of a center filling process.

Yet another object of the embodiments herein is to provide a manufacturing process for an all natural protein based wet and dry in one food product for the pets by adopting a unique mould at the outlet of an extruder to produce a wet and dry food in one product with a predetermined shape.

These and other objects and advantages of the embodiments herein will become readily apparent from the following detailed description taken in conjunction with the accompanying drawings.

### SUMMARY

The embodiments herein generally relate to an all natural protein based wet and dry food in one for the pets comprising a hard outer shell. The hard outer shell is made up of animal based protein and has a moisture content of 10-15%. The wet and dry food in one also comprises a wet and soft inner part. The wet and soft inner part includes a wet canned food.

According to one embodiment herein, the hard outer shell is coated with a dense and moist mixture of a protein and a liquid. The amount of protein present in the dense and moist mixture is 35% and the amount of liquid present in the dense and moist mixture is 65%.

According to one embodiment herein, the animal based protein is selected from a group consisting of a chicken, a turkey, a lamb, a duck and a combination thereof.

According to one embodiment herein, the protein is a meat-based protein.

According to one embodiment herein, the wet and soft inner part contains a protein formulation. The protein formulation is selected from a group consisting of a chicken formulation, a turkey formulation, a lamb formulation and a duck formulation.

According to one embodiment herein, the chicken formulation comprises chicken, poultry meal, potato starch, potato flour, glycerine (vegetable), dried egg, chicken liver, beet pulp, poultry fat, carrots, pea protein, dicalcium phosphate, tomato pomace, inulin, brewers dried yeast, vitamin E, folic acid, sunflower oil, naturox, zinc propionate and a premix.

The composition of above mentioned ingredients present in the chicken formulations are as follows. An amount of chicken present in the chicken formulation is 22.75%. An amount of poultry meal present in the chicken formulation is 22.75%. An amount of potato starch present in the chicken formulation is 9.1%. An amount of potato flour present in the chicken formulation is 9%. An amount of glycerine (vegetable) present in the chicken formulation is 9%. An amount of dried egg present in the chicken formulation is 5%. An amount of chicken liver present in the chicken formulation is 5%. An amount of beet pulp present in the chicken formulation is 4.29%, and wherein an amount of poultry fat present in the chicken formulation is 3.5%. An amount of carrots present in the chicken formulation is 3%. An amount of pea protein present in the chicken formulation is 2%. An amount of dicalcium phosphate present in the chicken formulation is 1.5%. An amount of tomoto pomace present in the chicken formulation is 1%. An amount of inulin present in the chicken formulation is 0.25%. An amount of brewers dried yeast present in the chicken formulation is 0.25%. An amount of vitamin E present in the chicken formulation is 0.25%. An amount of folic acid present in the chicken formulation is 0.25%. An amount of sunflower oil present in the chicken formulation is 0.25%. An amount of naturox present in the chicken formulation is 0.25%. An amount of zinc propionate present in the chicken formulation is 0.3% and an amount of premix present in the chicken formulation is 0.31%.

According to one embodiment herein, the turkey formulation comprises turkey, poultry meal, potato starch, potato flour, glycerine (vegetable), dried egg, chicken liver, beet pulp, poultry fat, sweet potato, pea protein, dicalcium phosphate, tomato pomace, inulin, brewers dried yeast, vitamin E, folic acid, sunflower oil naturox, zinc propionate and a premix.

The composition of above mentioned ingredients in the turkey formulation are as follows. An amount of turkey present in the turkey formulation is 22.75%. An amount of poultry meal present in the turkey formulation is 22.75%. An amount of potato starch present in the turkey formulation is 9.1%. An amount of potato flor present in the turkey formulation is 9%. An amount of glycerine (vegetable) present in the turkey formulation is 9%. An amount of dried egg present in the turkey formulation is 5%. An amount of chicken liver present in the turkey formulation is 5%. An amount of beet pulp present in the turkey formulation is 4.29%. An amount of poultry fat present in the turkey formulation is 3.5%. An amount of sweet potato present in the turkey formulation is 3%. An amount of pea protein present in the turkey formulation is 2%. An amount of dicalcium phosphate present in the turkey formulation is 1.5%. An amount of tomoto pomace present in the turkey formulation is 1%. An amount of inulin present in the turkey formulation is 0.25%. An amount of brewers dried yeast present in the turkey formulation is 0.25%. An amount of vitamin E present in the turkey formulation is 0.25%. An amount of folic acid present in the turkey formulation is 0.25%. An amount of sunflower oil present in the turkey formulation is 0.25%. An amount of naturox present in the turkey formulation is 0.25%. An amount of zinc propionate present in the turkey formulation is 0.3% and an amount of premix present in the turkey formulation is 0.31%.

According to one embodiment herein, the lamb formulation comprises lamb, turkey, poultry meal, potato, potato starch, glycerine (vegetable), dried egg, chicken liver, beet pulp, poultry fat, sweet potato, pea protein, dicalcium phosphate, tomato pomace, inulin, brewers dried yeast, vitamin/minerals, folic acid, sunflower oil naturox, zinc propionate and a premix.

The composition of above mentioned ingredients in the lamb formulation are as follows. An amount of lamb present in the lamb formulation is 15.35%. An amount of turkey present in the lamb formulation is 15.35%. An amount of poultry meal present in the lamb formulation is 15.05%. An amount of potato present in the lamb formulation is 9.1%. An amount of potato starch present in the lamb formulation is 9%. An amount of glycerine (vegetable) present in the lamb formulation is 9%. An amount of dried egg present in the lamb formulation is 5%. An amount of chicken liver present in the lamb formulation is 5%. An amount of beet pulp present in the lamb formulation is 4.29%. An amount of poultry fat present in the turkey formulation is 3.5%. An amount of sweet potato present in the lamb formulation is 3%. An amount of pea protein present in the lamb formulation is 2%. An amount of dicalcium phosphate present in the lamb formulation is 1.5%. An amount of tomato pomace present in the lamb formulation is 1%. An amount of inulin present in the lamb formulation is 0.25%. An amount of brewers yeast present in the lamb formulation is 0.25%. An amount of vitamin/minerals present in the lamb formulation is 0.31%. An amount of folic acid present in the lamb formulation is 0.25%. An amount of sunflower oil present in the lamb formulation is 0.25%. An amount of naturox present in the lamb formulation is 0.25%. An amount of zinc propionate present in the lamb formulation is 0.3% and wherein an amount of premix present in the lamb formulation is 0.31%.

According to one embodiment herein, the duck formulation comprises duck, turkey, chicken, potato, potato starch, glycerine (vegetable), poultry meal, chicken liver, beet pulp, pea protein, poultry fat, sweet potato, dicalcium phosphate, tomato pumace, zinc propionate, vitamin/minerals, brewers yeast, inulin, folic acid, sunflower oil naturox, and a premix.

The composition of above mentioned ingredients in the duck formulation are as follows. An amount of duck present in the duck formulation is 16%. An amount of turkey present in the duck formulation is 16%. An amount of chicken present in the duck formulation is 9%. An amount of potato present in the duck formulation is 11%. An amount of potato starch present in the duck formulation is 9%. An amount of glycerine (vegetable) present in the duck formulation is 9%. An amount of poultry meal present in the duck formulation is 8%. An amount of chicken liver present in the duck formulation is 5%. An amount of beet pulp present in the duck formulation is 4%. An amount of pea protein present in the duck formulation is 2%. An amount of poultry fat present in the duck formulation is 3.5%. An amount of sweet potato present in the duck formulation is 3%. An amount of dicalcium phosphate present in the duck formulation is 1.5%. An amount of tomoto pumace present in the duck formulation is 1%. An amount of zinc propionate present in the duck formulation is 0.3%. An amount of vitamin/minerals present in the duck formulation is 0.31%. An amount of brewers yeast present in the duck formulation is 0.25%. An amount of inulin present in the duck formulation is 0.25%. An amount of folic acid present in the duck formulation is 0.25%. An amount of sunflower oil present in the duck formulation is 0.25%. An amount of naturox present in the duck formulation is 0.25% and wherein an amount of premix present in the duck formulation is 0.31%.

According to one embodiment herein, each formulation includes protein, oil, fiber, carbohydrates, linoleic acid comprising omega 3, linoleic acid comprising omega 6, calcium, phosphorous and moisture content. An amount of protein present in the formulation is 24%. An amount of oil present in the formulation is 12%. An amount of fiber present in the formulation is 2%. An amount of ash present in the formulation is 5%. An amount of moisture content present in the formulation is 12%. An amount of carbohydrates present in the formulation is 45%. An amount of linoleic acid comprising omega 6 present in the formulation is 1%. An amount of linoleic acid comprising omega 3 present in the formulation is 0.12%. An amount of calcium present in the formulation is 1.6%. An amount of phosphorous present in the formulation is 0.9%, and the ratio of protein to carbohydrate in the formulation is 1:7.1.

According to one embodiment herein, a method of synthesizing a wet and dry food in one for pets is provided. The method comprises the steps of pre-processing a plurality of raw ingredients, conditioning a plurality of pre-processed raw ingredients, extruding a plurality of conditioned raw ingredients to obtain food sample, processing the extruded food sample, drying the extruded food sample in a drying oven, cooling the dried food sample at a cooler, coating the food sample after drying and cooling the food sample and labeling and packaging the food sample.

According to one embodiment herein, the step of drying the food sample at a drying oven comprises heating the food sample for a first time at a first temperature for a period of 30 minutes.

According to one embodiment herein, the step of coating comprises flash heating the food sample for a second time at a second temperature for 10 minutes. The second temperature is within 91-146° C.

According to one embodiment herein, comprises heating the food sample for a third time at a third temperature for 30 minutes.

According to one embodiment herein, the wet and hard food in one is hard from outside and wet from inside/middle. The hard (also known as “kibble”) characteristics of the wet and hard food in one product is essential in terms of a dental health of a pet by providing the teeth cleansing attributes. The hard food characteristics are generally found in a dry or kibble containing a very less moisture content with an adequate nutrition elements. The wet characteristics of the wet and hard food in one product provide an inherent natural texture with an increased palatability. Most of the pets such as dogs and cats, find a soft or wet food characteristics more appetizing than a hard/dry characteristics. The embodiments herein provide a pet food product with a combination of hard and wet pet food characteristics.

According to one embodiment herein, the wet and hard food in one product improves a health condition of the pet in various aspects, one of which being a dental health. In addition to the dental health, the wet and hard food in one product maintains the level of sugar and glycemic carbohydrates and also reduces the obesity rate in the pets. Thus the wet and hard food in one product is an all in one dietary supplement for the pets. The primary health issues concerning the pets are obesity (44% of the pets have obesity according to a U.S., source: American Veterinarian Association), which leads to other associated diseases, such as diabetes (and loss of vision), etc. An added inducement for the pets to eat the wet and hard food in one product is a mouth feel characteristic which increases a feel for the pets to eat a food thereby encouraging the pets to have a healthier eating habit. The pets are evolved to prefer the soft and hard elements from their original genetic predispositions as wolves. The wet and hard food in one product is all-natural and does not require any artificial palatability enhancers. The wet and hard food in one product is a unique protein based all-natural, which is the best type of “all natural” food for the pets such as dogs, cats etc. The digestive system of pets are optimized for the proteins and not for the complex carbohydrates, so that the energy produced is better assimilated and used, without producing the useless excess calories which leads to an extra weight/fat storage, etc.

According to one embodiment herein, the wet and dry food in one product exhibits a natural texture and an enhanced palatability. As far as the enjoyment and preference in the food is concerned, the pets are more heavily influenced by a mouth feel characteristics than a scent of the food. The wet and hard food in one product is formulated to provide all the essential nutrients required by the pets. The wet and hard food in one product is a high quality pet food which is carefully formulated to not only be highly nutritious, but also to be highly palatable as well.

According to one embodiment herein, the wet and hard food in one product does not require a mixing of any external wet food before feeding to the pet. In other words, the wet and hard food in one product is not mixed with any wet (canned) food, prior to a feeding to the pet, as the food already has a high inherent moisture content. The hard and wet components of the pet food retain their properties without affecting the properties of each other.

According to one embodiment herein, a unique mould is used at the outlet of an extruder. The unique mould provides a specific shape (preferably spherical shape) for the extruded food sample. To obtain a round spherical shaped extruded food sample, the flash heating process hardens the exterior surface consistently and evenly.

According to one embodiment herein, the drying and cooling phases in the step of manufacturing the wet and dry food in one product comprises a three step heating cycle. The wet component of wet and dry food in one product of the embodiments herein is not center filled as done in the existing method. The wet component of wet and dry food in one product is obtained by a three step heating of extruded food sample. By using the unique three step heating phase, the exterior surface of the extruded food sample becomes hard and crunchy and the inner content in the food product remains wet with a desired moisture content.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a side sectional view of an all natural protein-based wet and dry food in one for pets, according to one embodiment herein.

FIG. 2 illustrates a functional block diagram a system for manufacturing an all natural protein-based wet and dry food in one for pets, according to one embodiment herein.

FIG. 3 illustrates a flow chart explaining a method of manufacturing an all natural protein-based wet and dry food in one for pets, according to one embodiment herein.

FIG. 4 illustrates a flow chart for the collection, storing and pre-conditioning processes in a method of manufacturing an all natural protein-based wet and dry food in one for pets according to one embodiment herein.

FIG. 5A illustrates a flow chart for extruding, drying and enrobing processes in a method of manufacturing an all natural protein-based wet and dry food in one for pets according to one embodiment herein.

FIG. 5B illustrates a flow chart for screening and packaging processes in a method of manufacturing an all natural protein-based wet and dry food in one for pets according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein generally relate to an all natural protein based wet and dry food in one for the pets comprising a hard outer shell. The hard outer shell is made up of animal based protein and has a moisture content of 10-15%. The wet and dry food in one also comprises a wet and soft inner part. The wet and soft inner part includes a wet canned food.

According to one embodiment herein, the hard outer shell is coated with a dense and moist mixture of a protein and a liquid. The amount of protein present in the dense and moist mixture is 35% and the amount of liquid present in the dense and moist mixture is 65%.

According to one embodiment herein, the animal based protein is selected from a group consisting of a chicken, a turkey, a lamb, a duck and a combination thereof.

According to one embodiment herein, the protein is a meat based protein.

According to one embodiment herein, the wet and soft inner part contains a protein formulation. The protein formulation is selected from a group consisting of a chicken formulation, a turkey formulation, a lamb formulation, a duck formulation and a turkducken formulation.

According to one embodiment herein, the chicken formulation comprises chicken, poultry meal, potato starch, potato flour, glycerine (vegetable), dried egg, chicken liver, beet pulp, poultry fat, carrots, pea protein, dicalcium phosphate, tomato pomace, inulin, brewers dried yeast, vitamin E, folic acid, sunflower oil naturox, zinc propionate and a premix.

The composition of above mentioned ingredients present in the chicken formulations are as follows. An amount of chicken present in the chicken formulation is 22.75%. An amount of poultry meal present in the chicken formulation is 22.75%. An amount of potato starch present in the chicken formulation is 9.1%. An amount of potato flor present in the chicken formulation is 9%. An amount of glycerine (vegetable) present in the chicken formulation is 9%. An amount of dried egg present in the chicken formulation is 5%. An amount of chicken liver present in the chicken formulation is 5%. An amount of beet pulp present in the chicken formulation is 4.29%, and wherein an amount of poultry fat present in the chicken formulation is 3.5%. An amount of carrots present in the chicken formulation is 3%. An amount of pea protein present in the chicken formulation is 2%. An amount of dicalcium phosphate present in the chicken formulation is 1.5%. An amount of tomato pomace present in the chicken formulation is 1%. An amount of inulin present in the chicken formulation is 0.25%. An amount of brewers dried yeast present in the chicken formulation is 0.25%. An amount of vitamin E present in the chicken formulation is 0.25%. An amount of folic acid present in the chicken formulation is 0.25%. An amount of sunflower oil present in the chicken formulation is 0.25%. An amount of naturox present in the chicken formulation is 0.25%. An amount of zinc propionate present in the chicken formulation is 0.3% and an amount of premix present in the chicken formulation is 0.31%.

According to one embodiment herein, the turkey formulation comprises turkey, poultry meal, potato starch, potato flour, glycerine (vegetable), dried egg, chicken liver, beet pulp, poultry fat, sweet potato, pea protein, dicalcium phosphate, tomato pomace, inulin, brewers dried yeast, vitamin E, folic acid, sunflower oil naturox, zinc propionate and a premix.

The composition of above mentioned ingredients in the turkey formulation are as follows. An amount of turkey present in the turkey formulation is 22.75%. An amount of poultry meal present in the turkey formulation is 22.75%. An amount of potato starch present in the turkey formulation is 9.1%. An amount of potato flor present in the turkey formulation is 9%. An amount of glycerine (vegetable) present in the turkey formulation is 9%. An amount of dried egg present in the turkey formulation is 5%. An amount of chicken liver present in the turkey formulation is 5%. An amount of beet pulp present in the turkey formulation is 4.29%. An amount of poultry fat present in the turkey formulation is 3.5%. An amount of sweet potato present in the turkey formulation is 3%. An amount of pea protein present in the turkey formulation is 2%. An amount of dicalcium phosphate present in the turkey formulation is 1.5%. An amount of tomoto pomace present in the turkey formulation is 1%. An amount of inulin present in the turkey formulation is 0.25%. An amount of brewers dried yeast present in the turkey formulation is 0.25%. An amount of vitamin E present in the turkey formulation is 0.25%. An amount of folic acid present in the turkey formulation is 0.25%. An amount of sunflower oil present in the turkey formulation is 0.25%. An amount of naturox present in the turkey formulation is 0.25%. An amount of zinc propionate present in the turkey formulation is 0.3% and an amount of premix present in the turkey formulation is 0.31%.

According to one embodiment herein, the lamb formulation comprises lamb, turkey, poultry meal, potato, potato starch, glycerine (vegetable), dried egg, chicken liver, beet pulp, poultry fat, sweet potato, pea protein, dicalcium phosphate, tomato pomace, inulin, brewers dried yeast, vitamin/minerals, folic acid, sunflower oil naturox, zinc propionate and a premix.

The composition of above mentioned ingredients in the lamb formulation are as follows. An amount of lamb present in the lamb formulation is 15.35%. An amount of turkey present in the lamb formulation is 15.35%. An amount of poultry meal present in the lamb formulation is 15.05%. An amount of potato present in the lamb formulation is 9.1%. An amount of potato starch present in the lamb formulation is 9%. An amount of glycerine (vegetable) present in the lamb formulation is 9%. An amount of dried egg present in the lamb formulation is 5%. An amount of chicken liver present in the lamb formulation is 5%. An amount of beet pulp present in the lamb formulation is 4.29%. An amount of poultry fat present in the turkey formulation is 3.5%. An amount of sweet potato present in the lamb formulation is 3%. An amount of pea protein present in the lamb formulation is 2%. An amount of dicalcium phosphate present in the lamb formulation is 1.5%. An amount of tomoto pomace present in the lamb formulation is 1%. An amount of inulin present in the lamb formulation is 0.25%. An amount of brewers yeast present in the lamb formulation is 0.25%. An amount of vitamin/minerals present in the lamb formulation is 0.31%. An amount of folic acid present in the lamb formulation is 0.25%. An amount of sunflower oil present in the lamb formulation is 0.25%. An amount of naturox present in the lamb formulation is 0.25%. An amount of zinc propionate present in the lamb formulation is 0.3% and wherein an amount of premix present in the lamb formulation is 0.31%.

According to one embodiment herein, the duck formulation comprises duck, turkey, chicken, potato, potato starch, glycerine (vegetable), poultry meal, chicken liver, beet pulp, pea protein, poultry fat, sweet potato, dicalcium phosphate, tomato pumace, zinc propionate, vitamin/minerals, brewers yeast, inulin, folic acid, sunflower oil naturox, and a premix.

The composition of above mentioned ingredients in the duck formulation are as follows. An amount of duck present in the duck formulation is 16%. An amount of turkey present in the duck formulation is 16%. An amount of chicken present in the duck formulation is 9%. An amount of potato present in the duck formulation is 11%. An amount of potato starch present in the duck formulation is 9%. An amount of glycerine (vegetable) present in the duck formulation is 9%. An amount of poultry meal present in the duck formulation is 8%. An amount of chicken liver present in the duck formulation is 5%. An amount of beet pulp present in the duck formulation is 4%. An amount of pea protein present in the duck formulation is 2%. An amount of poultry fat present in the duck formulation is 3.5%. An amount of sweet potato present in the duck formulation is 3%. An amount of dicalcium phosphate present in the duck formulation is 1.5%. An amount of tomoto pumace present in the duck formulation is 1%. An amount of zinc propionate present in the duck formulation is 0.3%. An amount of vitamin/minerals present in the duck formulation is 0.31%. An amount of brewers yeast present in the duck formulation is 0.25%. An amount of inulin present in the duck formulation is 0.25%. An amount of folic acid present in the duck formulation is 0.25%. An amount of sunflower oil present in the duck formulation is 0.25%. An amount of naturox present in the duck formulation is 0.25% and wherein an amount of premix present in the duck formulation is 0.31%.

According to one embodiment herein, each formulation includes protein, oil, fiber, carbohydrates, linoleic acid comprising omega 3, linoleic acid comprising omega 6, calcium, phosphorous and moisture content. An amount of protein present in the formulation is 24%. An amount of oil present in the formulation is 12%. An amount of fiber present in the formulation is 2%. An amount of ash present in the formulation is 5%. An amount of moisture content present in the formulation is 12%. An amount of carbohydrates present in the formulation is 45%. An amount of linoleic acid comprising omega 6 present in the formulation is 1%. An amount of linoleic acid comprising omega 3 present in the formulation is 0.12%. An amount of calcium present in the formulation is 1.6%. An amount of phosphorous present in the formulation is 0.9%, and the ratio of protein to carbohydrate in the formulation is 1:7.1.

According to one embodiment herein, a method of synthesizing a wet and dry food in one for pets is provided. The method comprises the steps of pre-processing a plurality of raw ingredients, conditioning a plurality of pre-processed raw ingredients, extruding a plurality of conditioned raw ingredients to obtain food sample, processing the extruded food sample, drying the extruded food sample in a drying oven, cooling the dried food sample at a cooler, coating the food sample after drying and cooling the food sample and labeling and packaging the food sample.

According to one embodiment herein, the step of drying the food sample at a drying oven comprises heating the food sample for a first time at a first temperature for a period of 30 minutes.

According to one embodiment herein, the step of coating comprises flash heating the food sample for a second time at a second temperature for 10 minutes. The second temperature is within 91-146° C.

According to one embodiment herein, comprises heating the food sample for a third time at a third temperature for 30 minutes.

According to one embodiment herein, the wet and hard food in one is hard from outside and wet from inside/middle. The hard (also known as “kibble”) characteristics of the wet and hard food in one product is essential in terms of a dental health of a pet by providing the teeth cleansing attributes. The hard food characteristics are generally found in a dry or kibble containing a very less moisture content with an adequate nutrition elements. The wet characteristics of the wet and hard food in one product provide an inherent natural texture with an increased palatability. Most of the pets such as dogs and cats, find a soft or wet food characteristics more appetizing than a hard/dry characteristics. The embodiments herein provide a pet food product with a combination of hard and wet pet food characteristics.

According to one embodiment herein, the wet and hard food in one product improves a health condition of the pet in various aspects, one of which being a dental health. In addition to the dental health, the wet and hard food in one product maintains the level of sugar and glycemic carbohydrates and also reduces the obesity rate in the pets. Thus the wet and hard food in one product is an all in one dietary supplement for the pets. The primary health issues concerning the pets are obesity (44% of the pets have obesity according to a U.S., source: American Veterinarian Association), which leads to other associated diseases, such as diabetes (and loss of vision), etc. An added inducement for the pets to eat the wet and hard food in one product is a mouth feel characteristic which increases a feel for the pets to eat a food thereby encouraging the pets to have a healthier eating habit. The pets are evolved to prefer the soft and hard elements from their original genetic predispositions as wolves. The wet and hard food in one product is all-natural and does not require any artificial palatability enhancers. The wet and hard food in one product is a unique protein based all-natural, which is the best type of “all natural” food for the pets such as dogs, cats etc. The digestive system of pets are optimized for the proteins and not for the complex carbohydrates, so that the energy produced is better assimilated and used, without producing the useless excess calories which leads to an extra weight/fat storage, etc.

According to one embodiment herein, the wet and dry food in one product exhibits a natural texture and an enhanced palatability. As far as the enjoyment and preference in the food is concerned, the pets are more heavily influenced by a mouth feel characteristics than a scent of the food. The wet and hard food in one product is formulated to provide all the essential nutrients required by the pets. The wet and hard food in one product is a high quality pet food which is carefully formulated to not only be highly nutritious, but also to be highly palatable as well.

According to one embodiment herein, the wet and hard food in one product does not require a mixing of any external wet food before feeding to the pet. In other words, the wet and hard food in one product is not mixed with any wet (canned) food, prior to a feeding to the pet, as the food already has a high inherent moisture content. The hard and wet components of the pet food retain their properties without affecting the properties of each other.

According to one embodiment herein, a unique mould is used at the outlet of an extruder. The unique mould provides a specific shape (preferably spherical shape) for the extruded food sample. To obtain a round spherical shaped extruded food sample, the flash heating process hardens the exterior surface consistently and evenly.

According to one embodiment herein, the drying and cooling phases in the step of manufacturing the wet and dry food in one product comprises a three step heating cycle. The wet component of wet and dry food in one product of the embodiments herein is not center filled as done in the existing method. The wet component of wet and dry food in one product is obtained by a three step heating of extruded food sample. By using the unique three step heating phase, the exterior surface of the extruded food sample becomes hard and crunchy and the inner content in the food product remains wet with a desired moisture content.

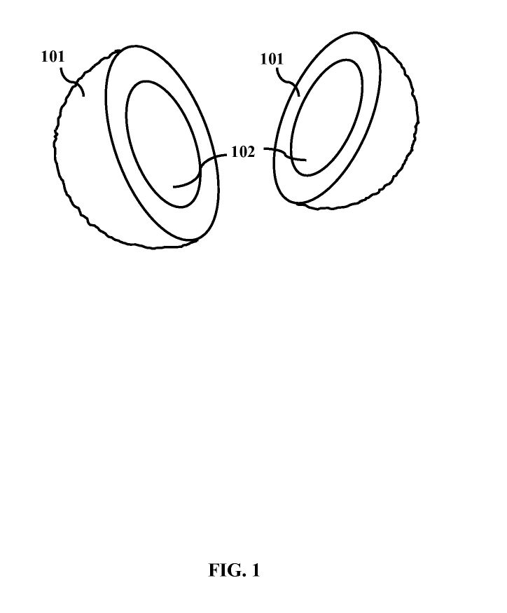

FIG. 1 illustrates a side sectional view of an all natural protein-based wet and dry food in one for pets, according to one embodiment herein. The pet food has two hemispherical halves of a single spherical two-in-one wet and dry food in a food product. The exterior surface 101 of the wet and dry food in one product is hard and crunchy. The exterior surface 101 is prepared by a three step heating cycle in the drying phase. The interior or middle portion 102 of the wet and dry food is wet and soft with high moisture content. The exterior surface 101 gives a natural texture appearance to pets. When the pets start consuming the wet and dry food in one product, the wet component increases the palatability of the food.

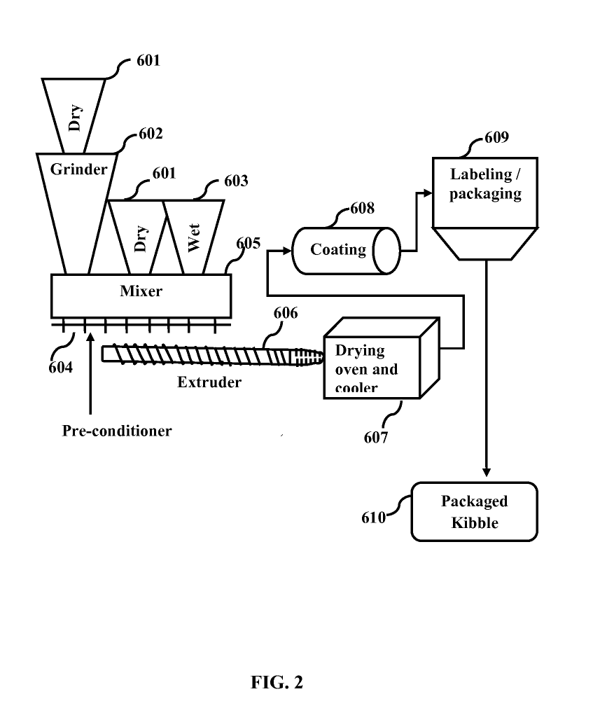

FIG. 2 illustrates a functional block diagram a system for manufacturing an all natural protein-based wet and dry food in one for pets, according to one embodiment herein. With respect to FIG. 2, the ingredients required to manufacture pet food product are fed into a mixer 605. The ingredients are a combination of wet raw materials 603 and dry raw materials 601, 602. Depending on the size of the dry ingredient 601, the dry ingredients 601 are either ground by a grinder 602 or directly fed to the mixer 605 along with the wet ingredients 604. The mixer 605 blends the ingredients and forms a moist dough of the ingredients. The moist dough is heated by a pre-conditioner 604 for removing any bacteria or other micro organisms. The pre-conditioned dough is forwarded to the extruder 606, where the processing of moist dough is carried out. The processing is performed at a controlled moisture and temperature settings. The moist dough undergoes cooking at intense heat and pressure, and reaches to the outlet of the extruder. At the outlet of the extruder 606, the processed hot dough passes through a die. The extruded hot dough is cut into the small pieces known as kibble. The kibble is dried to lower the moisture content and then cooled by a drying oven and cooler 607. The cooled kibble is coated with flavor enhancers, palatability enhancers etc., at a coating unit 608. The final coated kibble is sent to a labeling and packaging unit 609. The kibble is packaged as individual bags, bulk boxes etc 610.

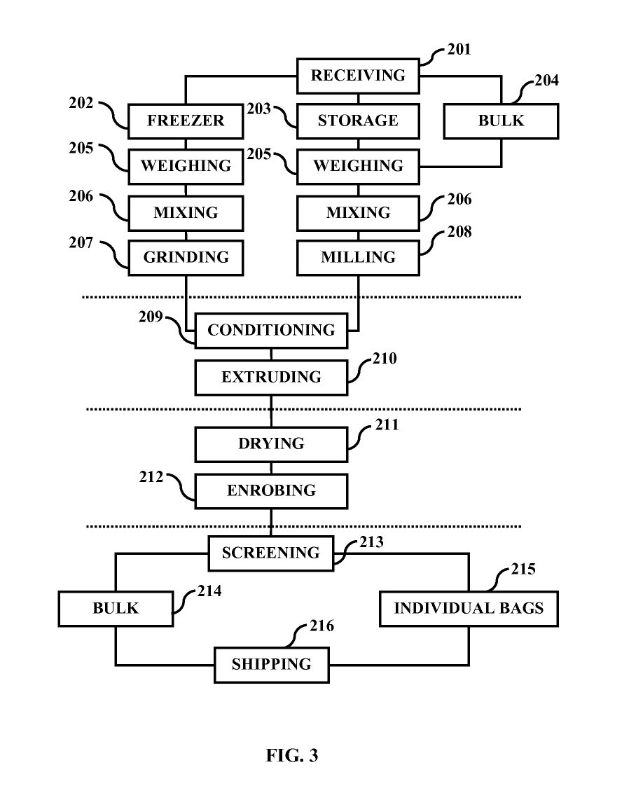

FIG. 3 illustrates a flow chart explaining a method of manufacturing an all natural protein-based wet and dry food in one for pets, according to one embodiment herein. With respect to FIG. 3, the method of manufacturing an all natural protein-based wet and dry food in one for pets describes the four steps of manufacturing the wet and dry food in one product. The four steps of manufacturing are arranged in sequence and separated by a dashed line for easy understanding. The first step involves collecting, storing and preconditioning a plurality of raw materials comprising high quality chicken or turkey or lamb or duck in bulk quantities along with the animal proteins (204). From the received bulk amount, a considerable amount of raw material is received for processing (201) or the bulk amount is sent for weighing directly (205). Based on the type of the raw materials, the receiving unit sends the raw material to different storage facilities. The raw materials which are prone to spoilage due to fast microbial actions are stored in the freezers (202). The other type of raw material is stored in the normal storage bins (203). The raw materials stored in a freezer or in storage unit is sent to a weighing machine for weighing the received raw materials (205). Based on the requirement, a respective quantity of raw material from the freezer is weighed (205). The weighed raw materials are preconditioned. During the preconditioned process, the weighed raw materials are sent to a mixing unit for mixing the raw materials with/without other ingredients properly (206). The mixing is followed by a grinding of the raw materials to reduce the size of the ingredients in the mixture (207). Sometimes the mixed raw materials are also milled to reduce the size of the ingredients with large sizes in the mixture (208). After a thorough grinding or milling, the grinded raw materials or the milled raw materials are sent to a conditioning unit (209).

During a conditioning process, the milled or grinded mixture is added with meat, heat treated with steam, and processed with water etc. The pre conditioned raw materials are sent to an extruder for obtaining a sample food product of a desired size and shape (210). The extruder is a cold press, semi-continuous twin screw extruder. The extrusion process generates the end products with an excellent surface finish. The cold extrusion process is carried out at a room temperature level, or near a room temperature or slightly above a room temperature level. The advantages of a cold extrusion process over a hot extrusion process are a lack of oxidation, higher strength due to a cold working, closer tolerances, a good surface finish, and fast extrusion speeds. However, those skilled in the art may adopt a process involving any combination of hot or cold press, continuous or semi-continuous, twin or single screw extruder. The conditioned mixture is extruded to obtain a food product of a desired size and shape by using a special unique mould. The mould is fixed to the outlet of the extruder. The mould produces a product of a desired shape (preferably round spherical shaped food products).

With respect to FIG. 3, the third stage of manufacturing process comprises drying and enrobing the extruded food product. The extruded food product is dried to obtain a hard shell comprising a dry food product with a desired moisture content (211). The drying process is a three step heating cycle comprises lightly heating the round shape extruded food sample (as a high-protein, all natural formula is used, so cooking is important for killing microorganisms) for a preset time. After stopping the initial drying process after a pre-determined time (may be thirty minutes), then the dried food sample is coated. Further, the coated product is flash heated with an intense heat for a pre-determined time (may be ten minutes). The above heating makes the exterior surface of the extruded food sample hard, thereby leaving the three-fourth of the interior of extruded food sample wet. Finally, the extruded food sample is reinserted into the dryer for a third time, at medium heat for a predetermined time (may be thirty minutes), and then cooled. The enrobing is generally the end phase, where the round dried pet food is coated or sprayed with liquefied lipid-based coating (which also serves as a natural flavor enhancer). Fat application, liquid application and palatability enhancer increases the aroma, taste and palatability and is thus applied on the exterior surface of the wet and dry food in one product (212).

With respect to FIG. 3, the fourth stage of manufacturing a dual textured pet food comprises packaging the enrobed wet and dry food in one product. The packaging includes screening the wet and dry food in one product for any deformation in size, change in weight etc (213). After screening the coated food products for defects in size, weight etc., the wet and dry food in one product is packaged either in bulk (214) or the wet and dry food products are packaged in individual bags (215) based on a requirement. The packed food product is then shipped to a required location (216).

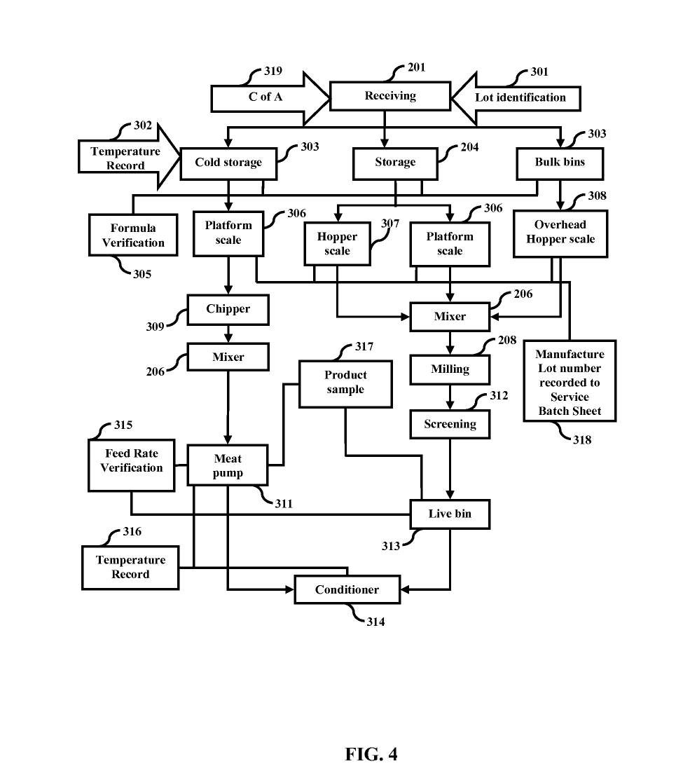

FIG. 4 illustrates a flow chart for the collection, storing and preconditioning processes in a method of manufacturing an all natural protein-based wet and dry food in one for pets according to one embodiment herein. With respect to FIG. 4, the raw material is first given with a certificate of analysis (C of A) (319). The C of A includes providing product-specific information such as storage conditions, quantity, and stability. The lot identification unit assigns unique number given to each manufacturing line to trace the wet and dry food in one product after shipping (301). After assigning the unique number to each manufacturing line, the raw material is received and stored in respective storage areas (201). In the embodiments herein, the raw material is stored in different storage facilities based on the type of material. The different storage facilities are a cold storage, a normal storage and bulk bins. The raw meat products which need to be stored for more than two days and which are prone to microbial spoilage are stored in cold storage (303). The temperature of the cold storage is typically at or below 0 degrees Celsius or 32 degrees Fahrenheit. The temperature record provides the temperature levels at which the delicate raw materials need to be stored (302). The storage in general is similar to cold storage, except that it is not refrigerated, and used for storing the process ingredients that can be stored at or below 60 degrees Fahrenheit for up to 48 hours (307). The bulk bins are used for storing the ingredients or bulk products that can be stored up to 1-2 weeks without having to be refrigerated to prevent a decay (304). A formula verification is carried out for receiving and mixing the raw materials (305). The formula verification is achieved by randomly selecting (sampling) an initial raw material from the manufacturing line. The selected sample undergoes a chemical analysis of the composition to verify the initial intermediate products that are consistent with the general formula guidelines. There are different scales for measuring the weights of raw material during the manufacturing process. The platform scales are used for weighing the raw materials stored in a cold storage facility (303). The raw materials stored in a normal storage facility which requires no refrigeration are weighed with a platform scale (306) or the raw materials stored in a normal storage facility which requires no refrigeration are weighed with a hopper scale (307). The raw materials stored in a bulk bin are weighed with an overhead hopper scale (308). The overhead scales are hung above the manufacturing line. The raw material from the cold storage is weighed in a platform scale and the weighed raw material is advanced to a chipper (309). The chipper cuts the raw material into many small pieces and sends to the mixer (206). The mixer combines the raw material along with any other feed ingredients to form a proper mixture. The above mixing and chipping of raw material is termed as a preconditioning process. The mixture containing the meat is pumped using a meat pump into conditioner for further processing (311). The mixture pumped to a conditioner is checked with a feed rate verification unit (315). The temperature of the mixture sent to the conditioning unit is monitored and registered in a temperature record (316).

Similarly, the raw materials stored in a storage are sent to a mixer 204 after weighing with a hopper scale or platform scale (206). Similarly the raw materials stored in bulk bins are sent to the mixer after weighing with an overhead scale (206). The mixture is forwarded to a milling unit for reducing the size of large sized ingredients into smaller sizes (208). Next, the milled mixture is screened for receiving the raw materials with a required or appropriate size (312). The screened raw materials are sent to a live bin (313). The live bin is the device used for feeding the powdered raw materials for processing. The mixing and milling of raw material is termed as preconditioning. The live bin stores the screened mixtures and feeds to the conditioner at a predefined rate. The raw materials from the live bin sent to the conditioner and the raw materials sent from the mixer are checked with a feed rate verification unit to ensure that the raw materials sent to the conditioner are at the required or specified rates. The meat pump is used to forward the mixture to a product sampling unit and then to a live bin. The temperature record maintains and records the temperature of the conditioner for controlled processing of preconditioned raw materials (316).

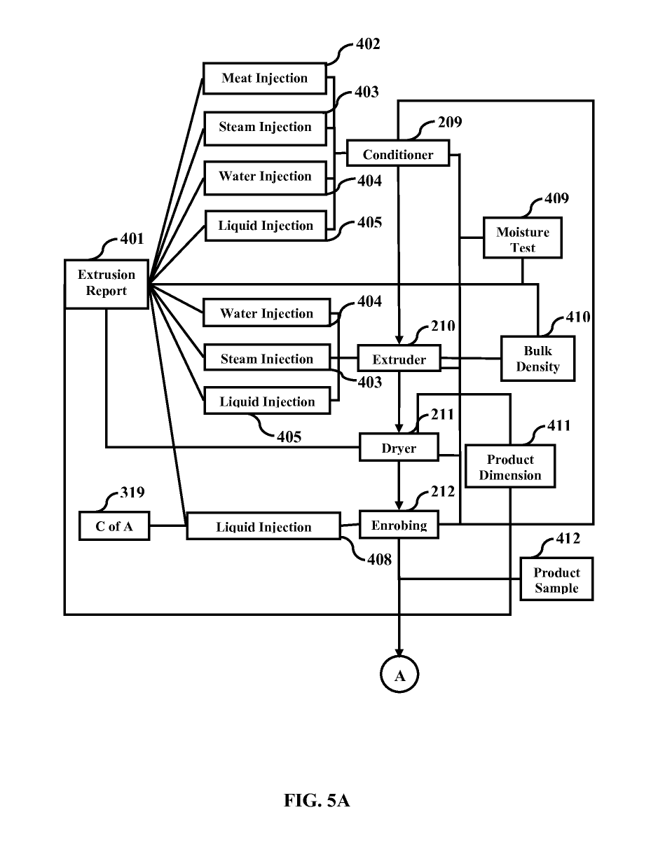

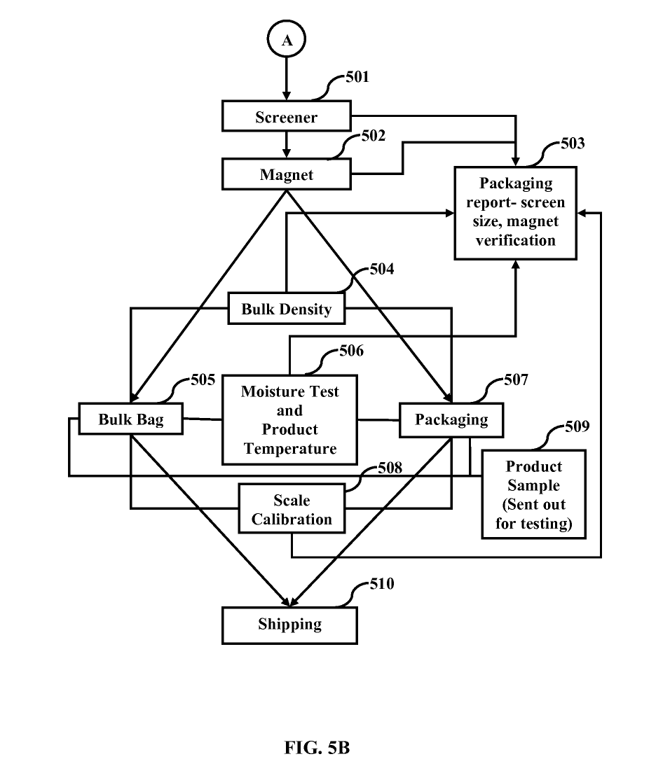

FIG. 5A illustrates a flow chart for extruding, drying and enrobing and packaging processes in a method of manufacturing an all natural protein-based wet and dry food in one for pets according to one embodiment herein. With respect to FIG. 5A, the second stage of manufacturing wet and dry food in one product comprises conditioning the raw materials and extruding the conditioned raw materials into a food product of a desired shape. During the conditioning of the pre-processed ingredients for the wet and dry food product for pets, the grinded meat ingredients are injected (401). Then steam is injected for sterilizing the contact surfaces of a product (402). Water is injected in appropriate volume (403) and a liquid is injected for pasteurization (404).

The extrusion of the conditioned ingredients in the extruder also includes a water injection, a steam injection and liquid injection operations (402-404). The injection of water, steam and liquid provides an adequate energy transfer during the extrusion process.

The preconditioned mixture is sent to a conditioner (209). The conditioner processes the preconditioned raw material.

The processing of preconditioned mixture comprises keeping the preconditioned mixture under hygienic conditions, without any other treatment. Storing the fresh raw meat at a freezing point (−1.5° C.) for about six weeks prevents a decay or spoilage, during which the meat undergoes an aging process to increase its tenderness and flavor. In the first day of receiving fresh raw meat, a process of glycolysis starts. The glycolysis is a metabolic pathway for converting a glucose into pyruvate. The glycolysis continues until the lactic acid is accumulated to make the pH to reach a level about 5.5. The remaining glycogen, about 18 g per kg, increases the water-holding capacity and tenderness of the flesh when cooked. The freshly received raw meat undergoes rigor mortis in few hours as adenosine triphosphate (ATP) is used in the process. Rigor mortis causes actin and myosin to combine into rigid actomyosin and lowers the meat's water-holding capacity and causes the meat to lose water (called as “weep”). In the muscles of fresh meat that undergoes rigor mortis, actin and myosin filaments overlap and cross-link with each other thereby resulting in a meat product that is tough on cooking The pre-slaughtering of animals is avoided before providing a raw fresh meat. The fresh meat muscle proteins denature in varying degrees over a period of time, with the exception of the collagen and elastin of connective tissue, and resolve the rigor mortis. Thus the meat is made tender and pliable when fresh raw meat is cooked just after death of the animal or after the resolution of rigor mortis, but the meat becomes tough when cooked during a rigor mortis stage. Also as there is a denaturing of a fresh meat muscle pigment called myoglobin, the oxidation of iron in the meat cause a brown discoloration near the surface of the meat. The ongoing proteolysis also contributes to a conditioning of the meat. Hypoxanthine, a breakdown product of adenosine triphosphate (ATP), contributes to the flavor and odour of meat similar to the decomposition of the other products of muscle fat and protein. The further processing of the meat comprises an application of meat, steam injection, water injection and liquid injection processes in addition to an application of heat as required. Pasteurization sterilization (canning), cleaning, sanitizing and membrane processing are performed by the application of the liquid and steam.

After conditioning the mixture of raw materials, the conditioned mixture is sent to an extruder to obtain a food product of a desired shape (210). The extruder is cold press, semi-continuous twin screw extruder. The twin screw extrusion process enables a continuous production of the homogenous compounds using natural raw materials. The active part of the twin screw extruder consists of two identical co-rotating and intermeshing screws. The screws are mounted on the shafts, supported by the bearings and rotate inside a fixed, closed housing called barrel. In order to employ the twin screw extruder equipment to different industrial applications, the screws, which perform the most of the works of transporting, conveying, mixing, compressing, kneading or shearing of raw materials, are designed to be totally modular. The screw segments are stacked one beside another on a splined shaft and are modified depending on the products to be processed and the final product to be achieved. The twin screw technology offers the advantages of a continuous process that is both flexible and easy to automate. The twin screw technology has the advantage of continuous processing of a plurality of functions such as conveying, melting, shearing, etc. depending on the industrial application. The conditioned mixture is extruded to the desired size and shape by using a special unique mould. Also in the extrusion phase, the application of steam, water, liquid etc. and heat are carried out as required. The mould is fixed at the outlet of the extruder. The mould is used to produce a food sample of desired shape (preferably round spherical shape) out of the extruded food samples. An extrusion report is maintained to record all of the sub-processes that are directly related to the extrusion process of the manufacturing of wet and hard food (401). The extrusion report records the extrusion related information and the extruded food sample is sent to a third stage of manufacturing of the wet and dry food.

The third stage of manufacturing wet and dry food in one product includes a drying process (211). The drying process comprises a drying process and a cooling process followed by an enrobing process of the extruded food sample (212). The drying process consists of lightly heating the extruded food sample, as a high-protein, all natural formula is used, and hence the cooking is important for killing microorganisms. Further, the initial drying process is stopped after a pre-determined time (such as thirty minutes) and then coating/enrobing of (or lightly basting) the dried extruded food sample is carried out. Further, a flash heating of the coated food sample is carried out at an intense heat for a pre-determined time (such as ten minutes). The above heating makes the exterior surface of the extruded food sample hard, thereby leaving the three-fourth of the interior of the extruded food sample wet. Finally, the extruded food sample is reinserted into the dryer for a third time to heat the extruded sample at a medium heat for a pre-determined time (such as thirty minutes), and then the food sample heat treated at a medium heat is cooled by a cooler. The dried food sample is cooled to a specified temperature and is forwarded to the enrobing process.

In the enrobing process, a liquid application is performed on the wet and hard food in one product. The liquid application is the process of mixing the liquids with the extruded solid food sample. The outside of the food sample is coated with a soft, dense and highly moist mixture of protein (35%) and liquid (65%). Once a dried food sample is enrobed, a product sample is taken out for inspection (412). The extrusion report also stores the dimensional values of the pet food product. The product dimension unit verifies the size and shape of the extruded food sample received at the dryer from the extruder (411). The moisture test unit examines the moisture content of the raw material in the conditioner and sends the moisture detail to the extrusion report (409). The bulk density unit ensures that the extruder processes a definite amount of conditioned raw material at a time and the same is recorded in extrusion report (410). Further, the enrobing process is a coating the outside of the wet and dry food in one product with a thin layer of flavor-rich hard cellulose & protein based shell (212).

FIG. 5B illustrates a flow chart for screening and packaging processes in a method of manufacturing an all natural protein-based wet and dry food in one for pets according to one embodiment herein. With respect to FIG. 5B, the enrobed wet and hard food in one product is received at screening unit (501). The wet and hard food in one is packaged as a bulk package or packaged into a plurality of small packages. The packaging step comprises screening the finished product for deficiencies such as size, shape, weight etc. (501). The screened details are notified to a computer (503). The screened wet and hard food in one product is packaged into a bulk package (505) or the screened wet and hard food in one product is packaged into small packages (507). The screening is used to eliminate misshaped product or excess water. The product is tested for detecting a moisture level and a product temperature is measured (506). When a specific area is found to have excess of 20% moisture after processing, then wet and hard food in one product is treated to eliminate the excess moisture content. The screening reels are very versatile and are used for dewatering and screening the wet and hard food in one product. The method of embodiments herein typically uses a metal mesh.

Further, a magnetic system is used to detect any metal that may have entered into the wet and hard food in one product during production, either from metal shavings from raw materials (coming in from other suppliers), or from internal production (502). The metal pieces come as small particles from the wear and tear of metal parts from a production machinery. While the presence of metals is unlikely, the safety precaution is critical due to the potential negative health impact on the pets ingesting any of the metal. The wet and hard food in one product is inspected for proper size, shape, weight and other relevant parameters and any deviation from the parameter is notified to a computer (503). The screened wet and hard food in one product is either sent for bulk bag packaging or individual packaging based on the requirement. The packed wet and hard food in one product is shipped to a desired location (510).

During packaging, moisture test is conducted to ensure the required moisture level in the package (506). The packaged wet and dry food in one product is also verified for the standard weight by using scale calibration (508). Before shipping the wet and dry food in one product to a required location, a sample from bulk bag and normal packages is sent out for a testing (509).

The various embodiments herein provide a dual texture pet food product in a single package for pets of all ages and breeds. The wet and dry food in one product also fulfills the health need such as teeth cleansing attributes. The wet and dry food in one product is inherently highly palatable and thus does not require mixing of wet (canned) food. The wet and dry food in one product contains high moisture and is highly palatable to maximize an enjoyment, utility and consumption of the pet. The wet and dry food in one product of the embodiments herein provides both hard/crunchy and wet characteristics in a single product and thus the pet owners find convenience and save time in feeding pets without the need of mixing the wet food. The wet and dry food in one product of the embodiments herein is cheaper when compared to existing individual hard and wet food. The wet and dry food in one product maintains the sugar and glycemic carbs level to an optimum level to reduce obesity in the pets.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An all natural protein based wet and dry food in one for pets comprising:
a hard outer shell and wherein the hard outer shell is made up of animal based protein and wherein the hard outer shell has a moisture content of 10-15%;
a soft inner core with higher moisture content.

2. The wet and dry oft and hard food in one according to claim 1, wherein the hard outer shell is coated with a dense and moist mixture of a liquefied protein and lipid mixture, and wherein an amount of protein present in the dense and moist mixture is 35% and wherein an amount of liquid present in the dense and moist mixture is 65%.

3. The wet and dry food in one according to claim 1, wherein the animal based protein is selected from a group consisting of a chicken, a turkey, a lamb, a duck and a combination thereof.

4. The wet and dry food in one according to claim 1, wherein the protein is a meat based protein.

5. The wet and dry food in one according to claim 1, wherein the soft inner core contains a protein formulation and wherein the protein formulation is selected from a group consisting of a chicken formulation, a turkey formulation, a lamb formulation, and a duck formulation.

6. The wet and dry food in one according to claim 1, wherein the chicken formulations comprising chicken, poultry meal, potato starch, potato flour, glycerine (vegetable), dried egg, chicken liver, beet pulp, poultry fat, carrots, pea protein, dicalcium phosphate, tomoto pomace, inulin, brewers dried yeast, vitamin E, folic acid, sunflower oil naturox, zinc propionate and a premix, and wherein an amount of chicken present in the chicken formulation is 22.75%, and wherein an amount of poultry meal present in the chicken formulation is 22.75%, and wherein an amount of potato starch present in the chicken formulation is 9.1%, and wherein an amount of potato flor present in the chicken formulation is 9%, and wherein an amount of glycerine (vegetable) present in the chicken formulation is 9.%, and wherein an amount of dried egg present in the chicken formulation is 5%, and wherein an amount of chicken liver present in the chicken formulation is 5%, and wherein an amount of beet pulp present in the chicken formulation is 4.29%, and wherein an amount of poultry fat present in the chicken formulation is 3.5%, and wherein an amount of carrots present in the chicken formulation is 3%, and wherein an amount of pea protein present in the chicken formulation is 2%, and wherein an amount of dicalcium phosphate present in the chicken formulation is 1.5%, and wherein an amount of tomoto pomace present in the chicken formulation is 1%, and wherein an amount of inulin present in the chicken formulation is 0.25%, and wherein an amount of brewers dried yeast present in the chicken formulation is 0.25%, and wherein an amount of vitamin E present in the chicken formulation is 0.25%, and wherein an amount of folic acid present in the chicken formulation is 0.25%, and wherein an amount of sunflower oil present in the chicken formulation is 0.25%, and wherein an amount of naturox present in the chicken formulation is 0.25%, and wherein an amount of zinc propionate present in the chicken formulation is 0.3% and wherein an amount of premix present in the chicken formulation is 0.31%.

7. The wet and dry food in one according to claim 1, wherein the turkey formulations comprising turkey, poultry meal, potato starch, potato flor, glycerine (vegetable), dried egg, chicken liver, beet pulp, poultry fat, sweet potato, pea protein, dicalcium phosphate, tomoto pomace, inulin, brewers dried yeast, vitamin E, folic acid, sunflower oil naturox, zinc propionate and a premix, and wherein an amount of turkey present in the turkey formulation is 22.75%, and wherein an amount of poultry meal present in the turkey formulation is 22.75%, and wherein an amount of potato starch present in the turkey formulation is 9.1%, and wherein an amount of potato flor present in the turkey formulation is 9%, and wherein an amount of glycerine (vegetable) present in the turkey formulation is 9%, and wherein an amount of dried egg present in the turkey formulation is 5%, and wherein an amount of chicken liver present in the turkey formulation is 5%, and wherein an amount of beet pulp present in the turkey formulation is 4.29%, and wherein an amount of poultry fat present in the turkey formulation is 3.5%, and wherein an amount of sweet potato present in the turkey formulation is 3%, and wherein an amount of pea protein present in the turkey formulation is 2%, and wherein an amount of dicalcium phosphate present in the turkey formulation is 1.5%, and wherein an amount of tomoto pomace present in the turkey formulation is 1%, and wherein an amount of inulin present in the turkey formulation is 0.25%, and wherein an amount of brewers dried yeast present in the turkey formulation is 0.25%, and wherein an amount of vitamin E present in the turkey formulation is 0.25%, and wherein an amount of folic acid present in the turkey formulation is 0.25%, and wherein an amount of sunflower oil present in the turkey formulation is 0.25%, and wherein an amount of naturox present in the turkey formulation is 0.25%, and wherein an amount of zinc propionate present in the turkey formulation is 0.3% and wherein an amount of premix present in the turkey formulation is 0.31%.

8. The wet and dry food in one according to claim 1, wherein the lamb formulations comprising lamb, turkey, poultry meal, potato, potato starch, glycerine (vegetable), dried egg, chicken liver, beet pulp, poultry fat, sweet potato, pea protein, dicalcium phosphate, tomoto pomace, inulin, brewers dried yeast, vitamin/minerals, folic acid, sunflower oil naturox, zinc propionate and a premix, and wherein an amount of lamb present in the lamb formulation is 15.35%, and wherein an amount of turkey present in the lamb formulation is 15.35%, and wherein an amount of poultry meal present in the lamb formulation is 15.05%, and wherein an amount of potato present in the lamb formulation is 9.1%, and wherein an amount of potato starch present in the lamb formulation is 9%, and wherein an amount of glycerine (vegetable) present in the lamb formulation is 9%, and wherein an amount of dried egg present in the lamb formulation is 5%, and wherein an amount of chicken liver present in the lamb formulation is 5%, and wherein an amount of beet pulp present in the lamb formulation is 4.29%, and wherein an amount of poultry fat present in the turkey formulation is 3.5%, and wherein an amount of sweet potato present in the lamb formulation is 3%, and wherein an amount of pea protein present in the lamb formulation is 2%, and wherein an amount of dicalcium phosphate present in the lamb formulation is 1.5%, and wherein an amount of tomoto pomace present in the lamb formulation is 1%, and wherein an amount of inulin present in the lamb formulation is 0.25%, and wherein an amount of brewers yeast present in the lamb formulation is 0.25%, and wherein an amount of vitamin/minerals present in the lamb formulation is 0.31%, and wherein an amount of folic acid present in the lamb formulation is 0.25%, and wherein an amount of sunflower oil present in the lamb formulation is 0.25%, and wherein an amount of naturox present in the lamb formulation is 0.25%, and wherein an amount of zinc propionate present in the lamb formulation is 0.3% and wherein an amount of premix present in the lamb formulation is 0.31%.

9. The wet and dry food in one according to claim 1, wherein the duck formulations comprising duck, turkey, chicken, potato, potato starch, glycerine (vegetable), poultry meal, chicken liver, beet pulp, pea protein, poultry fat, sweet potato, dicalcium phosphate, tomoto pumace, zinc propionate, vitamin/minerals, brewers yeast, inulin, folic acid, sunflower oil naturox, and a premix, and wherein an amount of duck present in the duck formulation is 16%, and wherein an amount of turkey present in the duck formulation is 16%, and wherein an amount of chicken present in the duck formulation is 9%, and wherein an amount of potato present in the duck formulation is 11%, and wherein an amount of potato starch present in the duck formulation is 9%, and wherein an amount of glycerine (vegetable) present in the duck formulation is 9%, and wherein an amount of poultry meal present in the duck formulation is 8%, and wherein an amount of chicken liver present in the duck formulation is 5%, and wherein an amount of beet pulp present in the duck formulation is 4%, and wherein an amount of pea protein present in the duck formulation is 2%, and wherein an amount of poultry fat present in the duck formulation is 3.5%, and wherein an amount of sweet potato present in the duck formulation is 3%, and wherein an amount of dicalcium phosphate present in the duck formulation is 1.5%, and wherein an amount of tomoto pumace present in the duck formulation is 1%, and wherein an amount of zinc propionate present in the duck formulation is 0.3%, and wherein an amount of vitamin/minerals present in the duck formulation is 0.31%, and wherein an amount of brewers yeast present in the duck formulation is 0.25%, and wherein an amount of inulin present in the duck formulation is 0.25%, and wherein an amount of folic acid present in the duck formulation is 0.25%, and wherein an amount of sunflower oil present in the duck formulation is 0.25%, and wherein an amount of naturox present in the duck formulation is 0.25%, and wherein an amount of premix present in the duck formulation is 0.31%.

10. The wet and dry food in one according to claim 1, wherein each formulation includes protein, oil, fiber, carbohydrates, linoleic acid comprising omega 3, linoleic acid comprising omega 6, calcium, phosphorous, and moisture content, and wherein an amount of protein present in the formulation is 24%, and wherein an amount of oil present in the formulation is 12%, and wherein an amount of fiber present in the formulation is 2%, and wherein an amount of ash present in the formulation is 5%, and wherein an amount of moisture content present in the formulation is 12%, and wherein an amount of carbohydrates present in the formulation is 45%, and wherein an amount of linoleic acid comprising omega 6 present in the formulation is 1%, and wherein an amount of linoleic acid comprising omega 3 present in the formulation is 0.12%, and wherein an amount of calcium present in the formulation is 1.6%, and wherein an amount of phosphorous present in the formulation is 0.9%, and wherein a ratio of protein to carbohydrate in the formulation 1:7.1.

11. A method of synthesizing a wet and dry food in one for pets comprising the steps of:
pre-processing a plurality of raw ingredients;
conditioning a plurality of pre-processed raw ingredients;
extruding a plurality of conditioned raw ingredients to obtain food sample;
processing the extruded food sample;
drying the extruded food sample in a drying oven;
cooling the dried food sample at a cooler;
coating the food sample after drying and cooling the food sample; and labeling and packaging the food sample.

12. The method according to claim 11, wherein the step of drying the food sample at a drying oven comprises heating the sample for a first time at a first temperature for a period of 30 minutes.

13. The method according to claim 12, wherein the step of coating comprises flash heating the food sample for a second time at a second temperature for 10 minutes, and wherein the second temperature is within 91-146° C.

14. The method according to claim 11, further comprises heating the food sample for a third time at a third temperature for 30 minutes.
